(19) United States
(12) Patent Application Publication
(10) Pub. No.: US 2026/0170262 A1
(43) Pub. Date: Jun. 18, 2026

(54) DIFFUSION SAFETY GUIDANCE

(71) Applicant: Amazon Technologies, Inc., Seattle, WA (US)

(72) Inventors: Yongxin Wang, Seattle, WA (US); Samuel Osebe, Amherst, MA (US); Weitong Ruan, Revere, MA (US); Rahul Gupta, Waltham, MA (US); Ninareh Mehrabi, Glendale, CA (US); Fan Yang, Westwood, MA (US); Qiuyu Chen, Seattle, WA (US); Prashan Wanigasekara, Arlington, MA (US)

(21) Appl. No.: 18/979,199

(22) Filed: Dec. 12, 2024

(51) Int. Cl. G06F 40/40

(52) U.S. Cl. CPC G06F 40/40

(57) ABSTRACT

Described are systems and processes for providing safety guidance in generating images to prevent the inclusion of harmful content and/or concepts in the generated images. Statistical properties may be determined for the dimensions of a noise vector at each time step of a diffusion denoising process to determine dimensions that have high risks of manifesting restricted content and/or are loosely correlated to an input prompt, and targeting the determined dimensions in applying one or more safety guidance vectors to noise vectors at each time step of the diffusion denoising process based on the statistical properties. This facilitates the generation of images that maintains alignment of the generated output image with the input text prompt while effectively implementing safety guidance to avoid harmful content and/or concepts.

### BACKGROUND

Recently, generative models have been increasingly able to generate high quality content. For example, many text-to-image models are able to generate images in response to text prompts provided by a user. Although the quality of images generated by such models has made significant improvements, the generation of images by such models that include certain restricted, harmful, and/or toxic content remains a concern. In this regard, certain techniques have been employed to curtail and mitigate the generation of images that include such restricted, harmful, and/or toxic content, many of the techniques cause degradation in the quality of the images at least from the prospective of prompt to image alignment.

### BRIEF DESCRIPTION OF THE DRAWINGS

FIG. 1 is a block diagram illustrating an exemplary computing environment, according to exemplary embodiments of the present disclosure.

FIG. 2 is a block diagram of an exemplary text-to-image latent diffusion model, according to exemplary embodiments of the present disclosure.

FIG. 3 is a block diagram illustrating noise vectors, according to exemplary embodiments of the present disclosure.

FIG. 4 is a flow diagram of an exemplary safety guidance image generation process, according to exemplary embodiments of the present disclosure.

FIG. 5 is a flow diagram of an exemplary latent diffusion process, according to exemplary embodiments of the present disclosure.

FIG. 6 is a block diagram illustrating an exemplary computing resource, according to exemplary embodiments of the present disclosure.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

As is set forth in greater detail below, exemplary embodiments of the present disclosure are generally directed to methods and systems for providing safety guidance in generating images to prevent the inclusion of certain content and/or concepts, such as harmful, restricted, and/or toxic content and/or concepts in the generated images. Exemplary embodiments of the present disclosure may be implemented in connection with diffusion models to provide dynamic safety guidance by identifying states associated with higher risks of unsafe content generation and selectively applying one or more safety guidance vectors during denoising to the identified states. For example, statistical properties may be determined for the dimensions of a noise vector at each time step of a diffusion denoising process, and one or more safety guidance vectors may be applied to the noise vectors at each time step of the diffusion denoising process based on the statistical properties. In exemplary implementations, a threshold may be determined in connection with the determined statistical properties, and the safety guidance vector(s) may be applied to dimensions of each noise vector based on whether the statistical properties of each dimension of the noise vector relative to the threshold. Additionally, unlike existing techniques, rather than applying a single safety guidance vector that encompasses all safety guidance concepts, according to aspects of the present disclosure, a safety guidance vector may be generated for each safety guidance concept, and only the safety guidance vectors corresponding to the safety guidance concepts that are relevant to the input prompt may be applied.

The exemplary embodiments of the present disclosure may be implemented in connection with a text-to-image latent diffusion model. In exemplary implementations, an input text prompt that describes the image to be generated is received by the text-to-image latent diffusion model. Based on the input text prompt, one or more relevant safety guidance vectors may be determined. The relevant safety guidance vectors may then be selectively applied to the dimensions of the noise vectors during the latent denoising of the noise vectors in generating the output image. In exemplary implementations, statistical properties may be determined for the dimensions of the noise vectors at each time step of the latent denoising process, and the relevant safety guidance vectors may be applied to the noise vectors at each time step based on a threshold. For example, a stochasticity, which may be inferred by a variance, may be determined for the dimensions of the noise vectors at each time step of the latent denoising process, and the relevant safety guidance vectors may be applied to the noise vectors based on the variances associated with each dimension and a variance threshold. According to aspects of the present disclosure, at each time step of the latent denoising process, variances for each dimension of the corresponding noise vector may be determined by generating multiple noise distribution samples and iteratively denoising the noise distribution samples based on the input text prompt. Accordingly, a variance may be determined for each dimension across the multiple noise distribution samples at each time step of the latent denoising process. The relevant safety guidance vectors may be applied to the dimensions of the noise vector at each time step based on the corresponding variances and a variance threshold.

Advantageously, exemplary embodiments of the present disclosure provide systems and methods for providing safety guidance in connection with diffusion-based text-to-image models without training and/or fine-tuning a model. Further, the exemplary embodiments of the present disclosure maintain alignment of the generated output image and the input text prompt while effectively implementing safety guidance to avoid certain content and/or concepts, such as harmful, restricted, and/or toxic. Accordingly, the systems and methods of the present disclosure does not require the consumption of significant time and resources typically associated with the curation of data and the training and/or fine-tuning of a model, while avoiding the introduction of artifacts and misalignment of the generated output image and the input text prompt that is typical in connection with existing methods and systems. Additionally, although exemplary embodiments of the present disclosure are described primarily in connection with latent diffusion models and harmful, restricted, and/or toxic content, embodiments of the present disclosure are more broadly applicable to the other diffusion models and other content and/or subject matter to be avoided (e.g., intellectual property rights, etc.) in connection with the generation of images.

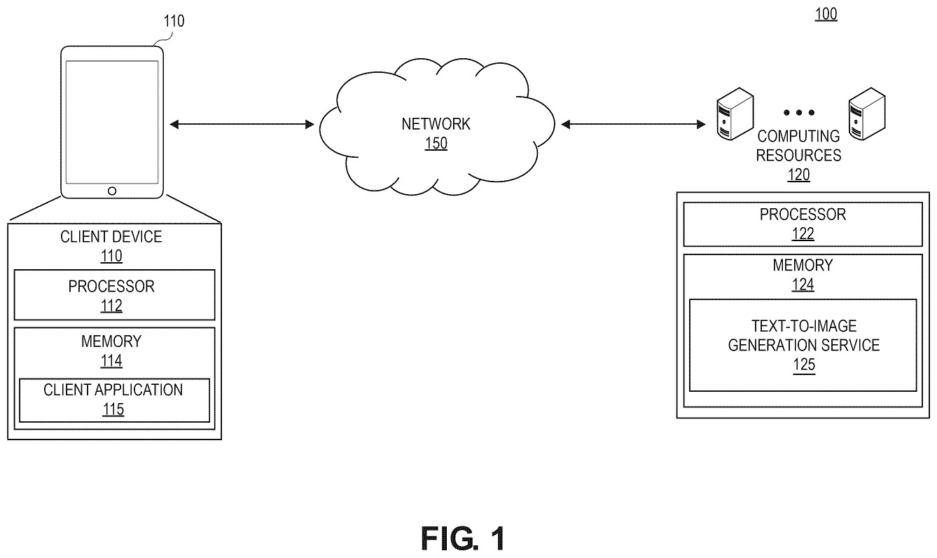

FIG. 1 is a block diagram illustrating an exemplary computing environment 100, according to exemplary embodiments of the present disclosure. It is noted that computing environment 100 is a logical configuration and is not necessarily an actual configuration. Indeed, there may be numerous ways in which computing environment 100 may be implemented, and FIG. 1 should be viewed as illustrative and not limiting.

As shown in FIG. 1, computing environment 100 may include one or more client devices 110, also referred to as user devices, for connecting over network 150 to access computing resources 120. Client device 110 may include any type of computing device, such as a smartphone, tablet, laptop computer, desktop computer, wearable, etc., and may include one or more processors 112 and one or more memory 114, which may store one or more applications, such as client application 115. Network 150 may include any wired or wireless network (e.g., the Internet, cellular, satellite, Bluetooth, Wi-Fi, etc.) that can facilitate communications between client device 110 and computing resources 120. Computing resources 120 may include one or more processors 122 and one or more memory 124, which may store one or more applications, such as text-to-image generation service 125, which may be executed by processor(s) 122 to cause the processor(s) 122 of computing resources 120 to perform various functions and/or actions.

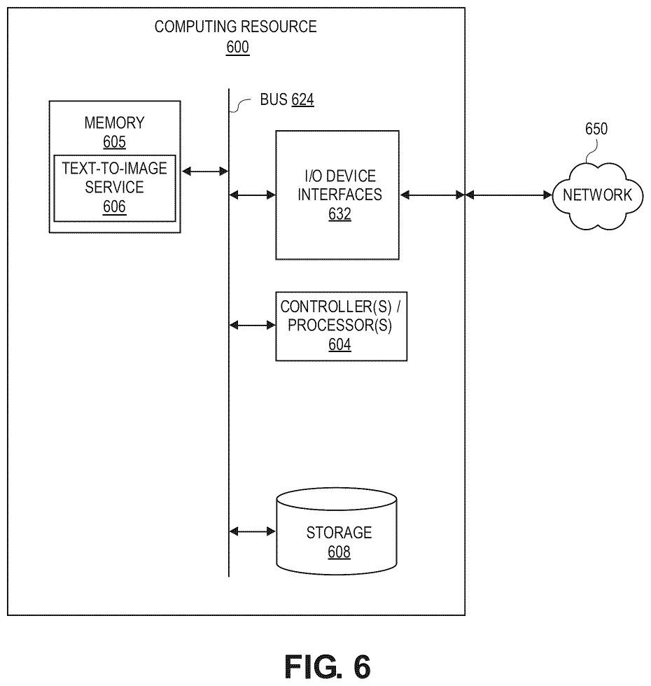

According to aspects of the present disclosure, computing resources 120 may represent at least a portion of a networked computing system that may be configured to provide online applications, services, computing systems, servers, and the like, that may be configured to execute on a networked computing system. In exemplary implementations of the present disclosure, computing resources 120 may be representative of computing resources that may form a portion of a larger networked computing system (e.g., a cloud computing system, and the like), which may be accessed by client device 110. Computing resources 120 may provide various services and/or resources and do not require end-user knowledge of the physical premises and configuration of the system that delivers the services. For example, computing resources 120 may include and/or form portions of systems that provide “cloud computing,” “on-demand computing,” “software as a service (Saas),” “infrastructure as a service (IaaS),” “network-accessible service,” “data centers,” “virtual computing,” and the like. Example components of a remote computing resource, which may be used to implement computing resources 120, are discussed below with respect to FIG. 6.

As illustrated in FIG. 1, client device 110 may access and/or interact with text-to-image generation service 125 through network 150 via one or more client applications 115 operating and/or executing on client device 110. For example, a user associated with client device 110 may launch and/or execute client application 115 to access and/or interact with applications and/or services executing on computing resources 120 via network 150. According to aspects of the present disclosure, a user may, via execution of client application 115 on client device 110, access or log into services executing on computing resources 120 by submitting one or more credentials (e.g., username/password, biometrics, secure token, etc.) through a user interface presented on client devices 110.

Once logged into services executing on remote computing resources 120, a user associated with client device 110 may navigate to, access, and/or otherwise associate with text-to-image generation service 125. In exemplary implementations, text-to-image generation service 125 may include a standalone application and/or service, be provided as part of a networking service, an e-commerce service, a social media service, or any other form of interactive computing. In connection with the user's activity on client device 110, a natural language text prompt may be received by computing resources 120 (and text-to-image generation service 125) from client device 110 for an image to be generated. For example, the natural language prompt may describe the image to be generated, describe one or more features of the image to be generated, and the like. Text-to-image generation service 125 may include one or more trained machine learning models, such as a variation autoencoder model (VAE), a generative adversarial model (GAN), an autoregression model, a diffusion model, a latent diffusion model, a stable diffusion model, and the like, that are configured to process the natural language prompt to generate an output image based on the input natural language prompt.

In an exemplary implementation of the present disclosure, text-to-image generation service 125 may include a diffusion model (e.g., diffusion model, latent diffusion model, stable diffusion model, etc.) that is configured to provide safety guidance in processing the input natural language prompt to generate an output image that preferably excludes certain content and/or concepts, such as harmful, restricted, and/or toxic. According to aspects of the present disclosure, text-to-image generation service 125 is configured to selectively apply one or more safety guidance vectors that represent corresponding safety guidance features to noise vectors during latent denoising in connection with generation of the output image. In selectively applying the safety guidance vectors, text-to-image generation service 125 determines certain statistical parameters for dimensions of noise vectors employed during the diffusion process. For example, the determined statistical parameters may reflect the latent states that are most likely to include harmful content, the dimensions that have the most freedom relative to the input natural language prompt (e.g., have the greatest relative variability in the diffusion process and/or a weak correlation to the input prompt), the dimensions that have the least freedom relative to the input natural language prompt (e.g., have the least relative variability in the diffusion process and/or a strong correlation to the input prompt), and the like. According to certain aspects of the present disclosure, these statistical parameters may include a variance of the dimensions (across multiple noise distributions), which can represent a stochasticity of the dimensions.

Accordingly, at each time step during the diffusion process, a statistical parameter, such as a variance, may be determined for each dimension of the corresponding noise vector across multiple noise samples. For example, n noise samples may be generated and iteratively denoised based on the input natural language prompt (e.g., using a U-net). The variance of each dimension may then be determined across the n samples. In addition to determining the variance of each dimension for noise vectors for each time step, a variance threshold may also be determined, and the safety guidance vectors may be selectively applied based on whether the variances associated with each dimension are greater than or less than the determined threshold. For example, the magnitude of the safety guidance vectors may be increased for dimensions having variances that exceed the threshold, while the magnitude of the safety guidance vectors may be maintained for the dimensions having variances that are less than the threshold. This selective application of the safety guidance vector preserves safety guidance for high variance dimensions while preserving prompt alignment for low variance dimensions (e.g., by reducing the relative safety guidance for low variance dimensions).

In connection with training a diffusion model for generating images conditioned on a text prompt cₚ, the model may be trained to estimate a joint distribution between unconditioned noise zₜ and prompt-conditioned noise, which may be represented as ϵ_{θ}(zₜ, cₚ). The unconditioned noise (e.g., ϵ_{θ}(zₜ)) may be subtracted from the joint noise (e.g., ϵ_{θ}(zₜ, cₚ)), which yields the prompt conditioned noise (e.g., ϵ_{θ}(cₚ)). The prompt conditioned noise (e.g., ϵ_{θ}(cₚ)) may then be scaled by a guidance function sg and added to the unconditioned noise (e.g., ϵ_{θ}(zₜ)), which can result in:

$${ϵ}_{θ}^{′} ( {z}_{t} , {c}_{p} ) = {ϵ}_{θ} ( {z}_{t} ) + {s}_{g} ( {ϵ}_{θ} ( {z}_{t} , {c}_{p} ) - {ϵ}_{θ} ( {z}_{t} ) )$$

which may represent a scale guidance operation (e.g., how much weight the conditioning prompt has on the generated image). In view of the scale guidance operation described above, implementations of the present disclosure can provide a safety guidance parameter φ(zₜ, cₚ, cₕ, τₖ), where cₕ may represent safety guidance concepts, which may be factorized into individual safety guidance concepts cₕᵢ, and τₖ may represent the k safety guidance concepts that are most similar to prompt cₚ (e.g., a cosine similarity between cₚ and cₕ). Applying the safety guidance parameter can provide:

$${\overline{ϵ}}_{θ} ( {z}_{t} , {c}_{p} ) = {ϵ}_{θ} ( {z}_{t} ) + {s}_{g} ( {ϵ}_{θ} ( {z}_{t} , {c}_{p} ) - {ϵ}_{θ} ( {z}_{t} ) ) - φ ( {z}_{t} , {c}_{p} , {c}_{h} , {τ}_{k} )$$

where the safety guidance parameter may be represented as:

$$φ ( {z}_{t} , {c}_{p} , {c}_{h} , {τ}_{k} ) = κ ( {G}_{n} ; α , β ) μ ( {c}_{p} , {c}_{h} , {τ}_{k} ; {S}_{s} , λ ) [ slerp ( {τ}_{k} , {c}_{h} , x ) - {ϵ}_{θ} ( {z}_{t} ) ]$$

where μ(cₚ, cₕ, τₖ; Sₛ, λ) [slerp (τₖ, cₕ, x)−ϵ_{θ}(zₜ)] may represent a safety guidance vector and κ(Gₙ; α, β) may represent a magnitude vector. To compensate for discrepancies in ranking safety guidance concepts, the top k ranked safety guidance concepts τₖ and the safety guidance concepts cₕ may be interpolated. In an exemplary implementation, a spherical linear interpolation technique may be utilized. This can compensate for safety guidance concepts that are encoded in the image space but absent from the text space. In exemplary implementations of the present disclosure, the spherical linear interpolation (slerp) may be represented as:

$$slerp ( {τ}_{k} , {c}_{h} , x ) = {ϵ}_{θ} ( {z}_{t} , {τ}_{k} ) \cdot \frac{sin ( 1 - x ) Ω}{sin Ω} + {ϵ}_{θ} ( {z}_{t} , {τ}_{k} ) \cdot \frac{sin x Ω}{sin x}$$

$$such that :$$

$$cos Ω = {ϵ}_{θ} ( {z}_{t} , {τ}_{k} ) \cdot {ϵ}_{θ} ( {z}_{t} , {c}_{h} )$$

Accordingly, slerp (τₖ, cₕ, x)−ϵ_{θ}(zₜ) may provide a vector of contextualized noise estimates for safety guidance concepts at each time step. This vector may be scaled by u, which may be represented as:

$$μ ( {c}_{p} , {c}_{h} , {τ}_{k} ; {S}_{s} , λ ) = \{ \begin{matrix}1 if {ϵ}_{θ} ( {z}_{k} , {τ}_{k} ) ⊖ slerp ( {τ}_{k} , {c}_{h} , x ) > λ \\ max ( 1 , \vert ϕ \vert ) otherwise\end{matrix}$$

$$where :$$

$$ϕ = {S}_{s} ( {ϵ}_{θ} ( {z}_{t} , {c}_{p} ) - slerp ( {τ}_{k} , {c}_{h} , x ) )$$

Accordingly, as represented in the equations above, dimensions having values greater than A can be understood to be encoding harmful information that is not semantically related to the input text prompt and are therefore not scaled. Otherwise, the element-wise difference between the prompt-conditioned estimate and the contextual safety guidance concept is scaled by Sₛ. The element-wise product μ(cₚ, cₕ, τₖ; Sₛ, λ) [slerp (τₖ, cₕ, x)−ϵ_{θ}(zₜ)] therefore scales the noise estimate for the contextualized safety guidance concept.

In view of the above, exemplary implementations of the present disclosure determines the variances of the dimensions of the latent states as a basis for identifying the dimensions of the latent states to which safety guidance mitigation is applied and the dimensions of the latent states for which safety guidance mitigation is not applied. For example, at an initial step of the latent diffusion process, N standard Gaussian samples that are similar but not identical are generated while fixing the generation seed. For each subsequent time step, n noise samples may be estimated for the input natural language prompt and the variance of each dimension may be computed cross-sectionally (e.g., across the n noise samples), normalized, and have a sigmoid function applied. According to certain aspects of the present disclosure, a vector that determines the magnitude of the safety guidance can be generated by shifting the normalized variance by −β if the value exceeds a threshold α or setting the value to 1 if the values do not exceed the threshold. This may be represented as:

$$κ ( {G}_{n} ; α , β ) = \{ \begin{matrix}S ( σ ( {G}_{n} ) ) - β & if S ( σ ( {G}_{n} ) ) > α \\ 1 & otherwise\end{matrix}$$

$$where :$$

$$S ( σ ( {G}_{n} ) ) = \frac{1}{1 + {e}^{- σ ( {G}_{n} )}}$$

Accordingly, the element-wise product of κ(Gₙ; α, β) (e.g., the magnitude vector) and safety guidance vector μ(cₚ, cₕ, τₖ; Sₛ, λ) [slerp (τₖ, cₕ, x)−ϵ_{θ}(zₜ)] can preserve safety guidance for high variance dimensions and scales it down for low variance dimensions, thereby preserving prompt alignment for low variance dimension, while increasing safety guidance for high variance dimensions.

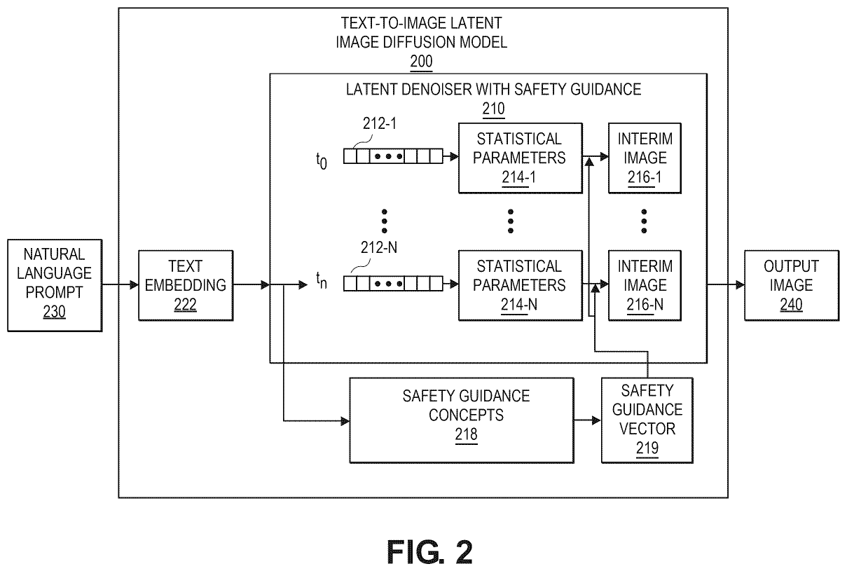

FIG. 2 is a block diagram of an exemplary text-to-image latent diffusion model 200, according to exemplary embodiments of the present disclosure.

As shown in FIG. 2, text-to-image latent diffusion model 200 may include latent denoiser with safety guidance 210 and may be configured to process natural language prompt 230 to generate output image 240. According to exemplary embodiments of the present disclosure, latent denoiser with safety guidance 210 of text-to-image latent diffusion model 200 may be configured to implement safety guidance in connection with the generation of output image 240 based on natural language prompt 230 to prevent the inclusion of certain content and/or concepts, such as harmful, restricted, and/or toxic content in output image 240.

According to aspects of the present disclosure, text-to-image latent diffusion model 200 is configured to selectively apply one or more safety guidance vectors 219 to noise vectors 212 (e.g., noise vectors 212-1 through 212-N) based on statistical parameters 214 (e.g., statistical parameters 214-1 through 214-N) that are determined for corresponding noise vectors 212 associated with each corresponding time step to through tN (during which interim images 216-1 through 216-N may be generated) in the latent denoising process in generating output image 240. As illustrated in FIG. 2, natural language prompt 230 may be processed (e.g., by text-to-image latent diffusion model 200 or other text to embedding generator) to generate text embedding 222. Text embedding 222 may include values that represent one or more features of natural language prompt 230, and, as one of ordinary skill in the art would understand, an embedding is a numerical representation of data that preserves various features, characteristics, meaning, context, semantic relationships, and information of the data in a fixed-length array of numbers. For example, an embedding May include 256 elements, 512 elements, 1024 elements, or any other number of elements, where each element may include floating point number to represent the data.

Text embedding 222 may be processed in connection with safety guidance concepts 218 to determine one or more safety guidance vectors 219. For example, safety guidance concepts 218 may include a plurality of embeddings that represent various safety guidance concepts, such as nudity, violence, guns, explicit language, self-harm, illegal activity, hateful content, sexually explicit content, harassing content, shocking content, and the like. According to aspects of the present disclosure, each embedding of safety guidance concepts 218 corresponds to a single safety guidance concepts so that each safety guidance concept is represented by a corresponding embedding (e.g., a one-to-one correspondence). Thus, exemplary embodiments of the present disclosure may only apply the safety guidance concepts that are relevant to the input prompt (e.g., natural language prompt 230), while excluding the application of safety guidance concepts that are irrelevant to the input prompt. In exemplary implementations, the safety guidance concept embeddings are generated by processing text prompts that describe the safety guidance concepts with a text to embedding generator. For example, a natural language prompt that describes the safety guidance concept may be generated for each safety guidance concept, and the natural language prompt may be processed using a text to embedding generator to generate an embedding that is representative of the natural language prompt (and the corresponding safety guidance concept). Further, other guidance concepts may also be included in connection with other content and/or subject matter to be avoided (e.g., intellectual property rights, etc.) in connection with the generation of output image 240.

In determining one or more safety guidance vectors 219, a relevance and/or a similarity measure may be determined between the embeddings included in safety guidance concepts 218 and text embedding 222. As understood by one of ordinary skill in the art, the distance between points in an embedding space represents semantic similarity of the data represented by the embedding vectors in the embedding space. For example, data that is considered to be semantically similar to each other will have similar embedding vectors that are close together in an embedding vector space. Accordingly, embedding vectors of data that is similar will cluster together in the embedding vector space. In exemplary implementations of the present disclosure, the relevance and/or similarity between the embeddings included in safety guidance concepts 218 and text embedding 222 may be determined based on distances in an embedding space (e.g., a Euclidean distance, a cosine similarity, nearest neighbor, and the like), and the embeddings that are within a threshold distance to text embedding 222 may be selected as safety guidance vectors 219.

As illustrated in FIG. 2, safety guidance vectors 219 may be selectively applied to noise vectors 212-1 through 212-N at each time step (e.g., time steps to through ty) based on statistical parameters 214. For example, the magnitude of safety guidance vectors 219 is varied based on statistical parameters 214 to vary the application of safety guidance vectors 219 to the various dimensions of the various latent states to balance safety guidance with prompt alignment. Preferably, safety guidance vectors 219 is more strongly applied to dimensions of latent states that are determined to be more likely to include harmful content and/or less likely to have an impact on prompt image alignment (e.g., the alignment of natural language prompt 220 to output image 240) and more weakly applied to dimensions of latent states that are determined to be less likely to include harmful content and/or more likely to have an impact on prompt image alignment (e.g., the alignment of natural language prompt 220 to output image 240). Accordingly, statistical parameters 214 may include a variance of each dimension of noise vectors 212, which may reflect a stochasticity of the dimensions of noise vectors 212 at the various time steps of the latent denoising process. For example, higher variance values for dimensions are typically indicative of greater variability, which corresponds to dimensions that are more likely to include harmful content and/or less likely to have an impact on prompt image alignment, and lower variance values for dimensions are typically indicative of lower variability, which corresponds to dimensions that are less likely to include harmful content and/or more likely to have an impact on prompt image alignment.

In exemplary implementations of the present disclosure, the variance of dimensions of noise vectors 212 may be determined at each time step by generating multiple noise samples and iteratively denoising the noise samples based on the input natural language prompt (e.g., using a U-net). The variance may be computed cross-sectionally (e.g., across the multiple noise samples) for each time step in the latent denoising process. For the initial time step in the latent denoising process, the noise samples may be generated from a standard Gaussian distribution with the same generation seed. Optionally, the variances may be normalized, and a sigmoid function may also be applied.

In addition to determining the variances, a variance threshold may be determined in connection with applying safety guidance vectors 219 to the dimensions of the latent states. Accordingly, safety guidance vectors 219 may be selectively applied to dimensions of noise vectors 212 based on whether the variances associated with each dimension of noise vectors 212 in each time step are greater than or less than the determined threshold. For example, the magnitude of safety guidance vectors 219 may be higher for dimensions having variances that exceed the threshold, while the magnitude of safety guidance vectors 219 may be lower for dimensions having variances that do not exceed the threshold. Accordingly, safety guidance vectors 219 may be applied (with varying magnitudes based on comparisons of the variances with the threshold) to dimensions of noise vectors 212 at each time step during the latent denoising process in generating output image 240. This selective application of the safety guidance vector preserves safety guidance for high variance dimensions while preserving prompt alignment for low variance dimensions (e.g., by reducing the relative safety guidance for low variance dimensions).

In exemplary implementations, the application of safety guidance may be represented as:

$$φ ( {z}_{t} , {c}_{p} , {c}_{h} , {τ}_{k} ) = κ ( {G}_{n} ; α , β ) μ ( {c}_{p} , {c}_{h} , {τ}_{k} ; {S}_{s} , λ ) [ slerp ( {τ}_{k} , {c}_{h} , x ) - {ϵ}_{θ} ( {z}_{t} ) ]$$

where μ(cₚ, cₕ, τₖ; Sₛ, λ) [slerp (τₖ, cₕ, x)−ϵ_{θ}(zₜ)] may represent a safety guidance vector and κ(Gₙ; α, β) may represent a magnitude vector where a is the variance threshold and:

$$κ ( {G}_{n} ; α , β ) = \{ \begin{matrix}S ( σ ( {G}_{n} ) ) - β & if S ( σ ( {G}_{n} ) ) > α \\ 1 & otherwise\end{matrix}$$

$$where :$$

$$S ( σ ( {G}_{n} ) ) = \frac{1}{1 + {e}^{- σ ( {G}_{n} )}}$$

In the above equations, zₜ may represent unconditioned noise, cₚ may represent an input text prompt (e.g., natural language prompt 230 and/or text embedding 222), ϵ_{θ}(zₜ) may represent unconditioned noise, cₕ may represent safety guidance concepts (e.g., safety guidance concepts 218), τₖ may represent the k safety guidance concepts that are most similar to prompt cₚ (e.g., safety guidance vectors 219), slerp (τₖ, cₕ, x) may represent a spherical linear interpolation of safety guidance concepts τₖ and the safety guidance concepts cₕ, slerp (τₖ, cₕ, x)−ϵ_{θ}(zₜ) may represent a vector of contextualized noise estimates for safety guidance concepts at each time step, which may be scaled by u, which scales the noise estimate for the contextualized safety guidance concept.

In view of the above, the element-wise product of κ(Gₙ; α, β) (e.g., the magnitude vector) and safety guidance vector μ(cₚ, cₕ, τₖ; Sₛ, λ)[slerp (τₖ, cₕ, x)−ϵ_{θ}(zₜ)] can preserve safety guidance for high variance dimensions and scales it down for low variance dimensions, thereby preserving prompt alignment for low variance dimension, while increasing safety guidance for high variance dimensions, in generating output image 240.

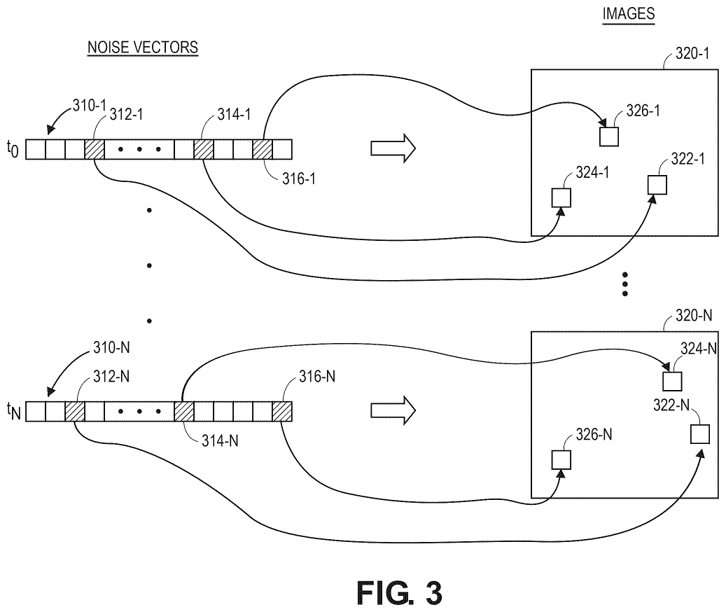

FIG. 3 is a block diagram illustrating noise vectors 310, according to exemplary embodiments of the present disclosure. FIG. 3 illustrates how dimensions of noise vectors 310 may correlate to images during a latent denoising process, according to exemplary embodiments of the present disclosure.

FIG. 3 is an exemplary illustration of how dimensions of noise vectors 310 associated with time steps to through ty of a latent denoising process correspond to regions of images 320 (e.g., images 320-1 through 320-N). As shown in FIG. 3, during time step to of the illustrated latent denoising process, dimension 312-1 of noise vector 310-1 may correspond with region 322-1 of image 320-1, dimension 314-1 of noise vector 310-1 may correspond with region 324-1 of image 320-1, and dimension 316-1 of noise vector 310-1 may correspond with region 326-1 of image 320-1. Similarly, during time step ty of the illustrated latent denoising process, dimension 312-N of noise vector 310-N may correspond with region 322-N of image 320-N, dimension 314-N of noise vector 310-N may correspond with region 324-N of image 320-N, and dimension 316-N of noise vector 310-N may correspond with region 326-N of image 320-N.

As illustrated in FIG. 3 and according to exemplary implementations of the present disclosure, statistical parameters associated with the dimensions may be computed to determine a magnitude of safety guidance to be applied to dimensions of noise vectors 310. For example, the statistical parameters can facilitate determining which dimensions are more likely to include harmful content and/or less likely to have an impact on prompt image alignment, and which dimensions are more weakly applied to dimensions of latent states that are determined to be less likely to include harmful content and/or more likely to have an impact on prompt image alignment.

According to exemplary implementations, the statistical parameter computed to distinguish between the dimensions of noise vectors 310 may include variance of the dimensions. For example, the variance of dimensions of noise vectors 320 may be determined at each time step by generating multiple noise samples and iteratively denoising the noise samples based on the input natural language prompt (e.g., using a U-net). The variance may be computed cross-sectionally (e.g., across the multiple noise samples) for each time step in the latent denoising process. For the initial time step in the latent denoising process, the noise samples may be generated from a standard Gaussian distribution with the same generation seed. Optionally, the variances may be normalized, and a sigmoid function may also be applied.

In addition to determining the variances, a variance threshold may be determined in connection with applying safety guidance vectors to the dimensions of the latent states. Accordingly, the safety guidance vectors may be selectively applied to dimensions of noise vectors 320 based on whether the variances associated with each dimension of noise vectors 320 in each time step are greater than or less than the determined threshold. For example, the magnitude of safety guidance vectors may be higher for dimensions having variances that exceed the threshold, while the magnitude of safety guidance vectors may be lower for dimensions having variances that do not exceed the threshold. Accordingly, safety guidance vectors may be applied (with varying magnitudes based on comparisons of the variances with the threshold) to dimensions of noise vectors 320 at each time step during the latent denoising process in generating an output image. This selective application of the safety guidance vector preserves safety guidance for high variance dimensions while preserving prompt alignment for low variance dimensions (e.g., by reducing the relative safety guidance for low variance dimensions).

As illustrated, the magnitude of the safety guidance vector in connection with its application to dimension 312-1 of noise vector 310-1 may affect the denoising of the image in connection with the generation of region 322-1. Similarly, the magnitude of the safety guidance vector in connection with its application to dimension 314-1 of noise vector 310-1 may affect the denoising of the image in connection with the generation of region 324-1, the magnitude of the safety guidance vector in connection with its application to dimension 316-1 of noise vector 310-1 may affect the denoising of the image in connection with the generation of region 326-1, the magnitude of the safety guidance vector in connection with its application to dimension 312-N of noise vector 310-N may affect the denoising of the image in connection with the generation of region 322-N, the magnitude of the safety guidance vector in connection with its application to dimension 314-N of noise vector 310-N may affect the denoising of the image in connection with the generation of region 324-N, and the magnitude of the safety guidance vector in connection with its application to dimension 316-N of noise vector 310-N may affect the denoising of the image in connection with the generation of region 326-N.

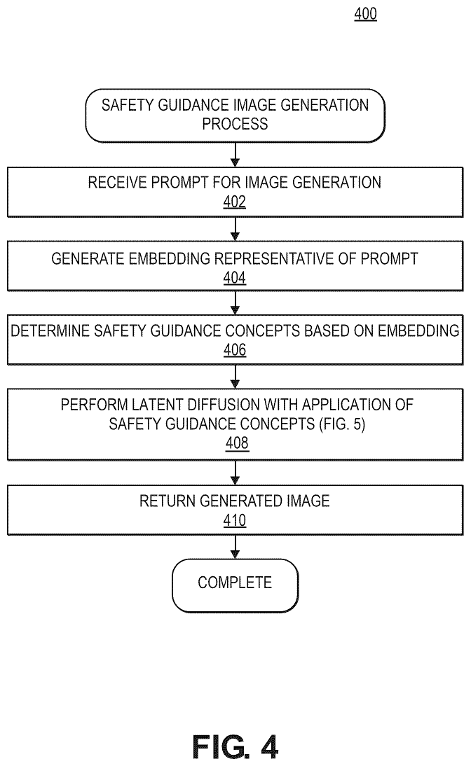

FIG. 4 is a flow diagram of an exemplary safety guidance image generation process 400, according to exemplary embodiments of the present disclosure. In exemplary implementations, exemplary safety guidance image generation process 400 may be performed by a text-to-image latent diffusion model to prevent an image generated by the text-to-image latent diffusion model from including certain harmful and/or toxic content in the generated image.

As shown in FIG. 4, process exemplary safety guidance image generation process 400 may begin by receiving a prompt (e.g., a natural language prompt) in connection with an image to be generated, as in step 402. For example, the received prompt may describe the image to be generated, features of the image to be generated, and the like. In step 404, the prompt may be processed to generate an embedding that is representative of the prompt. The embedding may be generated by the text-to-image latent diffusion model or other text-to-embedding generator.

In step 406, the embedding may be processed to determine one or more safety guidance concepts to apply. For example, the embedding may be processed determine one or more safety guidance concepts (from a plurality of safety guidance concepts). For example, the plurality of safety guidance concepts may include concepts, such as nudity, violence, guns, explicit language, self-harm, illegal activity, hateful content, sexually explicit content, harassing content, shocking content, and the like, and may be represented by a plurality of embeddings. According to aspects of the present disclosure, each safety guidance concept may be represented by a corresponding safety guidance embedding (e.g., a one-to-one correspondence). For example, a natural language prompt generated for each safety guidance concept may be processed by a text to embedding generator to generate the safety guidance embeddings. Further, other guidance concepts may also be included in connection with other content and/or subject matter to be avoided (e.g., intellectual property rights, etc.) in connection with the generation of an output image.

In determining the safety guidance concepts, a relevance and/or a similarity measure may be determined between the safety guidance embeddings representing each of the plurality of safety guidance concepts and the embedding generated in step 404. In exemplary implementations of the present disclosure, the relevance and/or similarity between the safety guidance embeddings representing each of the plurality of safety guidance concepts and the embedding generated in step 404 may be determined based on distances in an embedding space (e.g., a Euclidean distance, a cosine similarity, nearest neighbor, and the like), and the embeddings that are within a threshold distance to embedding generated in step 404 may be selected as the safety guidance concepts.

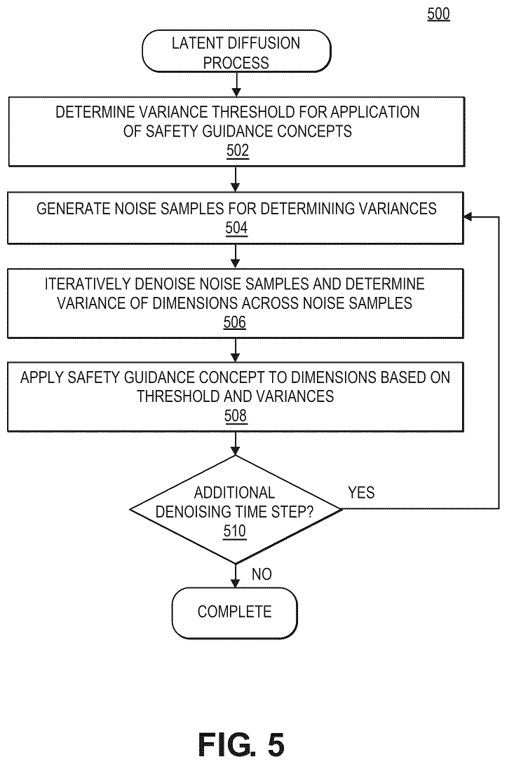

As illustrated in FIG. 4, a latent diffusion process may be performed with the application of the determined safety guidance concepts in generating an output image, as in step 408. According to exemplary implementations of the present disclosure, the safety guidance concepts may be iteratively applied at each time step in the latent denoising process. For example, the safety guidance concepts may be applied to dimensions of noise vectors associated with latent states of the latent diffusion process with varying magnitudes based on statistical parameters associated with the dimensions. According to aspects of the present disclosure, the varying magnitude of the safety guidance concepts may be applied with a greater magnitude to dimensions to target dimensions that are more likely to include harmful content and/or less likely to have an impact on prompt image alignment, while applying a smaller magnitude to dimensions that are more less likely to include harmful content and/or more likely to have an impact on prompt image alignment. Application of the safety guidance concepts during the latent diffusion process is discussed in further detail herein in connection with at least FIG. 5. In step 410, the output image generated from the latent diffusion process is returned.

FIG. 5 is a flow diagram of an exemplary latent diffusion process 500, according to exemplary embodiments of the present disclosure.

As shown in FIG. 5, process exemplary diffusion process 500 may begin with the determination of a variance threshold value for the application of one or more safety guidance concepts, as in step 502. According to exemplary implementations of the present disclosure, the variance threshold may determine a degree to which safety guidance concepts are applied to dimensions of noise vectors of time steps in a latent diffusion process. For example, application of the safety guidance concepts may be varied across the dimensions of the noise vectors associated with the time steps of a diffusion process to prevent the inclusion of certain harmful and/or restricted content in an output image being generated, while ensure that the output image aligns with the input prompt provided for generation of the image.

In steps 504 and 506, statistical parameters may be determined for the dimensions of the noise vectors associated with a particular time step in the denoising process. In exemplary implementations, the statistical parameters may include a variance of each dimension of the noise vectors, which may reflect a stochasticity of the dimensions of the noise vectors at the various time steps of the latent denoising process. For example, higher variance values for dimensions are typically indicative of greater variability, which corresponds to dimensions that are more likely to include harmful content and/or less likely to have an impact on prompt image alignment, and lower variance values for dimensions are typically indicative of lower variability, which corresponds to dimensions that are less likely to include harmful content and/or more likely to have an impact on prompt image alignment.

As shown in FIG. 5, in step 504, multiple noise samples may be first generated, and in step 506, the noise samples may be iteratively denoised based on the received prompt (e.g., using a U-net) to determine the variance cross-sectionally (e.g., across the multiple noise samples) for the particular time step in the denoising process. For the initial time step in the latent denoising process, the noise samples may be generated from a standard Gaussian distribution with the same generation seed. Optionally, the variances may be normalized, and a sigmoid function may also be applied.

In step 508, the safety guidance concept may be selectively applied to dimensions of the noise vectors based on whether the variances associated with each dimension of the noise vectors in the particular time step are greater than or less than the determined variance threshold. For example, the magnitude of the safety guidance concept may be higher for dimensions having variances that exceed the variance threshold, while the magnitude of the safety guidance concept may be lower for dimensions having variances that do not exceed the threshold. Accordingly, the safety guidance concept may be applied (with varying magnitudes based on comparisons of the variances with the threshold) to dimensions of the noise vectors at the particular time step during the denoising process in generating an output image. Accordingly, at step 510, it may be determined whether an additional denoising time step is to be performed, and in the event another denoising time step is to be performed, process 500 returns to step 504. Otherwise, process 500 completes.

FIG. 6 is a block diagram illustrating an exemplary computing resource 600, according to exemplary embodiments of the present disclosure. Computing resources 600 may be used in connection with the described implementations (e.g., computing resources 120, etc.).

In exemplary implementations, multiple such computing resources 600 may be included in the system. In operation, each of these devices (or groups of devices) may include computer-readable and computer-executable instructions that reside on computing resource 600, as will be discussed further below. Further, it is noted that computing resource 600 is a logical configuration and is not necessarily an actual configuration. Indeed, there may be numerous ways in which computing resource 600 may be implemented, and FIG. 6 should be viewed as illustrative and not limiting. In operation, each of these devices (or groups of devices) may include computer-readable and computer-executable instructions that reside on computing resource 600, as will be discussed further below.

Computing resource 600 may include one or more controllers/processors 604, that may each include a CPU for processing data and computer-readable instructions, and memory 605 for storing data and instructions. Computing resource may also communicate with other computing resources via external network 650. Memory 605 may individually include volatile RAM, non-volatile ROM, non-volatile MRAM, and/or other types of memory. Computing resource 600 may also include a data storage component 608 for storing data, user actions, content items, user information, content information, other supplemental information, etc. Each data storage component may individually include one or more non-volatile storage types such as magnetic storage, optical storage, solid-state storage, etc. Computing resource 600 may also be connected to removable or external non-volatile memory and/or storage (such as a removable memory card, memory key drive, networked storage, etc.) through input/output device interfaces 632.

Computer instructions for operating computing resource 600 and its various components may be executed by the controller(s)/processor(s) 604, using memory 605 as temporary “working” storage at runtime. The computer instructions may be stored in a non-transitory manner in non-volatile memory 605, storage 608, or an external device(s). Alternatively, some or all of the executable instructions may be embedded in hardware or firmware on computing resource 600 in addition to or instead of software.

For example, memory 605 may store program instructions that when executed by the controller(s)/processor(s) 604 cause the controller(s)/processors 604 to execute text-to-image service 606, which may include a diffusion model (e.g., diffusion model, latent diffusion model, stable diffusion model, etc.) and be configured to process an input prompt (e.g., a natural language prompt), determine statistical parameters associated with noise vectors used in a diffusion denoising process, apply safety guidance to the noise vectors based on a threshold value, to generate an output image, and the like, as discussed herein.

Computing resource 600 also includes input/output device interface 632. A variety of components may be connected through input/output device interface 632. Additionally, computing resource 600 may include address/data bus 624 for conveying data among components of computing resource 600. Each component within computing resource 600 may also be directly connected to other components in addition to (or instead of) being connected to other components across bus 624.

The disclosed implementations discussed herein may be performed on one or more computing resources, such as computing resource 600 discussed with respect to FIG. 6 or performed on a combination of one or more computing resources. Further, the components of the computing resource 600, as illustrated in FIG. 6, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular embodiment herein may also be applied, used, or incorporated with any other embodiment described herein, and that the drawings and detailed description of the present disclosure are intended to cover all modifications, equivalents and alternatives to the various embodiments as defined by the appended claims. Persons having ordinary skill in the field of computers, communications, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow chart shown in FIGS. 4 and 5, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Aspects of the disclosed system may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented by a volatile computer memory, non-volatile computer memory, hard drive, solid-state memory, flash drive, removable disk, and/or other media.

The data and/or computer-executable instructions, programs, firmware, software and the like (also referred to herein as “computer-executable” components) described herein may be stored on a computer-readable medium that is within or accessible by computers or computer components such as computing resources 120 and/or computing resources 600, client device 110, or to any other computers or control systems, and having sequences of instructions which, when executed by a processor (e.g., a central processing unit, or “CPU”), cause the processor to perform all or a portion of the functions, services and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal,

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly,” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A computing system, comprising:
one or more processors; and
a memory storing program instructions that, when executed by the one or more processors, cause the one or more processors to at least:
receive a natural language prompt specifying an image to be generated;
process, using a trained machine learning model, the natural language prompt to generate a text embedding that is representative of the natural language prompt;
determine, based at least in part on the text embedding and a first plurality of safety guidance vectors, a second plurality of safety guidance vector from the first plurality of safety guidance vectors, wherein the second plurality of safety guidance vectors is to be applied during generation of the image;
process, using the trained machine learning model, the text embedding and the second plurality of safety guidance vectors to generate the image, wherein:
the trained machine learning model includes a diffusion model architecture configured to iteratively denoise, based at least in part on the text embedding and the second plurality guidance vectors, a plurality of noise vectors representing a plurality of noise distributions over a plurality of time steps;
each time step of the plurality of time steps is associated with a respective noise vector of the plurality of noise vectors; and
denoising the plurality of noise vectors over the plurality of time steps includes:
determining, for each time step of the plurality of time steps, a first plurality of variances for a plurality of dimensions of the respective noise vector; and
applying, for each time step of the plurality of time steps and based at least in part on the first plurality of variances, the second plurality of safety guidance vectors to the plurality of dimensions of the respective noise vector.

2. The computing system of claim 1, wherein the trained machine learning model includes a latent diffusion model architecture and the iterative denoising is performed in the latent space.

3. The computing system of claim 1, wherein determining the at least one safety guidance vector includes determining a cosine similarity between the text embedding and the first plurality of safety guidance vectors.

4. The computing system of claim 1, wherein:
each of the first plurality of safety vectors is associated with a corresponding safety guidance concept that corresponds to content that is to be avoided in generating the image.

5. The computing system of claim 1, wherein applying the second plurality of safety guidance vectors to the plurality of dimensions of the respective noise vector includes:
determining a variance threshold for the plurality of dimensions; and
applying the second plurality of safety guidance vectors to the plurality of dimensions based at least in part on the threshold.

6. The computing system of claim 5, wherein:
applying the second plurality of safety guidance vectors to the plurality of dimensions of the respective noise vector further includes:
determining that a second plurality of variances of the first plurality of variances exceed the variance threshold, wherein the second plurality of variances are associated with a third plurality of dimensions;
applying the second plurality of safety guidance vectors to the third plurality of dimensions of the respective noise vector using a first magnitude;
determining that a third plurality of variances of the first plurality of variances do not exceed the variance threshold, wherein the third plurality of variances are associated with a fourth plurality of dimensions; and
applying the second plurality of safety guidance vectors to the third plurality of dimensions of the respective noise vector using a second magnitude; and
the first magnitude is greater than the second magnitude.

7. A computer-implemented method, comprising:
receiving a text embedding that represents a natural language prompt specifying an image to be generated;
performing, using a trained diffusion model and based at least in part on the text embedding and a first safety guidance vector, a plurality of denoising time steps, wherein performing the plurality of denoising time steps includes:
denoising, for each time step of the plurality of denoising time steps, a plurality of sample noise distributions to determine a plurality of statistical parameters for a first plurality of dimensions of a respective noise vector associated with each time step of the plurality of denoising time steps; and
applying, for each time step of the plurality of denoising time steps and based at least in part on a threshold and the plurality of statistical parameters, the first safety guidance vector to the first plurality of dimensions of the respective noise vector.

8. The computer-implemented method of claim 7, wherein the plurality of statistical parameters indicate a stochasticity of the first plurality of dimensions.

9. The computer-implemented method of claim 7, wherein the plurality of statistical parameters includes a plurality of variances for the first plurality of dimensions.

10. The computer-implemented method of claim 9, wherein applying the first safety guidance vector includes:
determining a second plurality of dimensions of the first plurality of dimensions having first variances that exceed the threshold; and
applying the first safety guidance vector to the second plurality of dimensions of the respective noise vector using a first magnitude.

11. The computer-implemented method of claim 10, wherein:
applying the first safety guidance vector includes:
determining a third plurality of dimensions of the first plurality of dimensions having second variances that do not exceed threshold; and
applying the first safety guidance vector to the second plurality of dimensions of the respective noise vector using a second magnitude; and
the first magnitude is greater than the second magnitude.

12. The computer-implemented method of claim 7, wherein the trained diffusion model includes a latent diffusion model and the plurality of denoising time steps are performed using a latent denoiser.

13. The computer-implemented method of claim 7, wherein the first safety guidance vector is determined based at least in part on a similarity between the first safety guidance vector and the text embedding.

14. The computer-implemented method of claim 7, wherein:
the first safety guidance vector is associated with a safety guidance concept that corresponds to content that is to be avoided in generating the image.

15. A computer-implemented method, comprising:
receiving, at a trained text-to-image model, a natural language prompt describing an image to be generated;
processing, using the trained text-to-image model, the natural language prompt to generate a text embedding representative of the natural language prompt;
determining, based at least in part on the text embedding, a first safety guidance vector from a plurality of safety guidance vectors;
performing, using the trained text-to-image model, a first denoising time step, wherein performing the first denoising time step includes:
determining a first plurality of variances for a first plurality of dimensions of a first noise vector; and
denoising the first vector to generate a second noise vector while applying the first safety guidance vector to the first noise vector based at least in part on the first plurality of variances;
performing, using the trained text-to-image model, a second denoising time step, wherein performing the second denoising time step includes:
determining a second plurality of variances for a second plurality of dimensions of the second noise vector; and
denoising the second vector to generate a third noise vector while applying the first safety guidance vector to the second noise vector based at least in part on the second plurality of variances.

16. The computer-implemented method of claim 15, wherein determining the first plurality of variances for the first plurality of dimensions of the noise vector includes:
generating a plurality of sample noise distributions;
denoising the plurality of sample noise distributions; and
determining the variances of the first plurality of dimensions across the plurality of sample noise distributions.

17. The computer-implemented method of claim 15, wherein:
denoising the first vector to generate the second noise vector while applying the first safety guidance vector to the first noise vector includes:
determining a variance threshold;
determining, based at least in part on the variance threshold and the first plurality of variances, a first magnitude of the first safety guidance vector for a third plurality of dimensions of the first plurality of dimensions; and
using the first magnitude for the third plurality of dimensions in applying the first safety guidance vector to the first noise vector.

18. The computer-implemented method of claim 17, wherein:
denoising the first vector to generate the second noise vector while applying the first safety guidance vector to the first noise vector includes:
determining, based at least in part on the variance threshold and the first plurality of variances, a second magnitude of the first safety guidance vector for a fourth plurality of dimensions of the first plurality of dimensions; and
using the second magnitude for the fourth plurality of dimensions in applying the first safety guidance vector to the first noise vector; and
the first magnitude is greater than the second magnitude.

19. The computer-implemented method of claim 15, wherein the first plurality of variances represents a variability between the first plurality of dimensions and the image generated based on the natural language prompt.

20. The computer-implemented method of claim 15, wherein determining the first safety guidance vector from a plurality of safety guidance vectors is based at least in part on a similarity of the first safety guidance vector and the text embedding.
